(19) United States
(12) Patent Application Publication
(10) Pub. No.: US 2015/0362161 A1
(43) Pub. Date: Dec. 17, 2015

(54) LAMPSHADE FOR BACKLIGHT MODULE, BACKLIGHT MODULE AND DISPLAY DEVICE

(71) Applicants: BOE TECHNOLOGY GROUP CO., LTD., Beijing (CN); BEIJING BOE OPTOELECTRONICS TECHNOLOGY CO., LTD., Beijing (CN)

(72) Inventors: Liang GAO, Beijing (CN); Zijian WANG, Beijing (CN)

(21) Appl. No.: 14/498,501

(22) Filed: Sep. 26, 2014

(30) Foreign Application Priority Data
Jun. 16, 2014 (CN) 201410267146.2

(51) Int. Cl. F21V 19/00; F21V 29/508; F21S 8/08; F21V 23/00

(52) U.S. Cl. CPC F21V 19/0025; F21V 23/005; F21V 29/508; F21S 8/08; F21Y 2101/02

(57) ABSTRACT

Embodiments of the present invention relates to a lampshade for a backlight module, a backlight module and a display device. The lampshade comprises a first portion, a second portion and a third potion connected between the first portion and the second portion; the third portion includes a first side and a second side opposite to the first side. The first portion, the second portion and the third portion form a groove on the first side of the third portion. The third portion is provided with at least one through hole communicated with the groove, and the at least one through hole is configured to allow at least one light-emitting unit to pass therethrough while not allow a circuit board to pass therethrough.

### TECHNICAL FIELD

Embodiments of the present invention relates to a lampshade for a backlight module, a backlight module and a display device.

### BACKGROUND

Backlight module is a main part of a display device and mainly configured to provide a light source for a display panel. As illustrated in FIG. 1, a backlight module in related art mainly comprises a lampshade, light-emitting diode (LED) lamps, a circuit board, a backplane and optical films. FIG. 1 is a partial schematic structural view of the backlight module in the related art. A lampshade 01 includes a groove 011 for accommodating a circuit board 02 and LED lamps 03; one side of the bottom of the groove 011 away from an opening is bonded with a backplane 04; the plurality of LED lamps 03 are welded on the circuit board 02; and the side of the circuit board away from the plurality of LED lamps welded is adhered to the bottom of the groove 011 through double-faced adhesive tape 05.

The LED lamps will generate heat in the light-emitting process. In the backlight module in the related art, it is not easy for the heat generated by the LED lamps to form natural convection in an internal space of the backlight module. and the heat is transmitted to the backplane 04 through the lampshade 01 and the double-faced adhesive tape 05 and emitted out through the backplane 04 (the heat conduction direction is as shown by a unidirectional arrow in FIG. 1). Obviously, in the backlight module in the related art, the heat generated by the LED lamps pass through a larger number of carriers in the unidirectional conduction process, and is restricted by the thermal resistivity in the conduction process, and hence the LED lamps have poor heat dissipation capacity.

### SUMMARY

An embodiment of the present disclosure provides a lampshade for a backlight module, the backlight module comprising a circuit board and at least one light-emitting unit disposed on the circuit board, wherein the lampshade comprises a first portion, a second portion and a third potion connected between the first portion and the second portion; the third portion includes a first side and a second side opposite to the first side; the first portion, the second portion and the third portion form a groove on the first side of the third portion; the third portion is provided with at least one through hole communicated with the groove, and the at least one through hole is configured to allow the at least one light-emitting unit to pass therethrough while not allow the circuit board to pass therethrough.

Another embodiment of the present disclosure provides a backlight module comprising a backplane, a circuit board attached to the backplane, at least one light-emitting unit disposed on the circuit board and the lampshade as described above, wherein, the at least one light-emitting unit pass through at least one through hole such that at least one portion of the at least one light-emitting unit is disposed in the groove on the first side of the third portion of the lampshade and the circuit board is disposed on the second side of the third portion of the lampshade opposite to the first side.

A further embodiment of the disclosure provides a display device comprising the backlight module as described above.

### BRIEF DESCRIPTION OF THE DRAWINGS

For more clear understanding of the technical proposals of the embodiments of the present disclosure, simple description will be given below to the accompanying drawings required to be used in the description of the embodiments or the related art. Obviously, the accompanying drawings illustrated below only involve some embodiments of the present disclosure and are not intended to limit the disclosure.

FIG. 1 is a partial schematic structural view of a backlight module in a related art;

FIG. 2 is a partial structural perspective view of a lampshade provided by an embodiment of the present disclosure;

FIG. 3 is a partial structural perspective view of a backlight module provided by an embodiment of the present disclosure; and

FIG. 4 is a sectional view in the A-A direction of the partial structural perspective view of the backlight module provided by the embodiment as shown in FIG. 3 of the present disclosure.

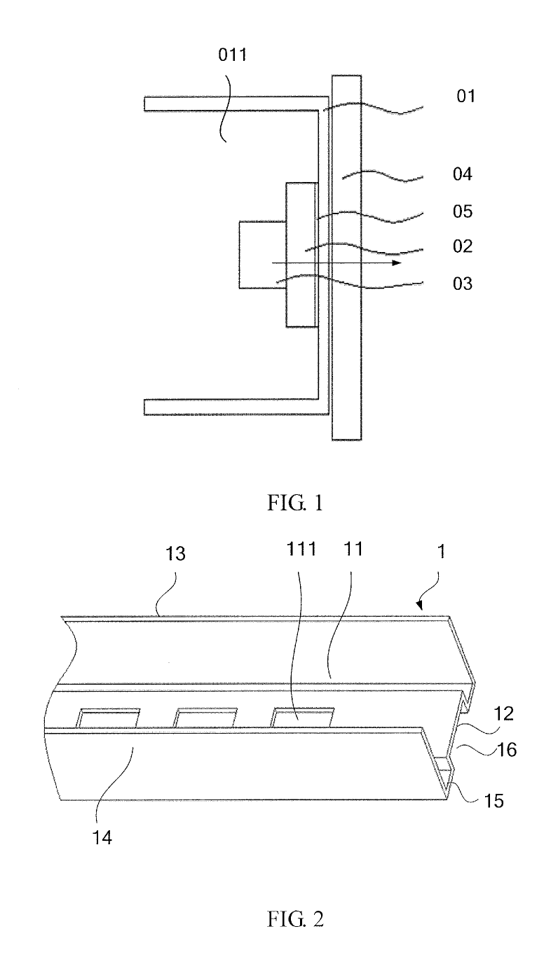

### DETAILED DESCRIPTION

Clear and complete description will be given below to the technical proposals of the embodiments of the present disclosure with reference to the accompanying drawings. It will be obvious to those skilled in the art that the preferred embodiments are only partial embodiments of the present disclosure but not all the embodiments. All the other embodiments obtained by those skilled in the art without creative efforts on the basis of the embodiments of the present disclosure shall fall within the scope of protection of the present disclosure.

### First Embodiment

The first embodiment of the present disclosure provides a lampshade for a backlight module, which has good heat dissipation function.

FIG. 2 is a partial structural perspective view of the lampshade provided by the first embodiment of the present disclosure. As illustrated in FIG. 2, the embodiment of the present disclosure provides a lampshade 1 for a backlight module, which comprises a first side plate 13, a second side plate 14 and a third side plate 15, wherein a groove 11 is formed on the inner side (namely the first side) of the third side plate 15, with an opening towards the first direction.

For example, the third side plate 15 is provided with a bonding surface 12 on the outer side (namely the second side) away from the direction of the opening of the groove 11, so as to bond with a circuit board in the backlight module; a plurality of through holes 111 communicated with the groove 11 are formed in the third side plate of the lampshade 1. Each through hole 111 is configured to, on one hand, allow at least one LED lamp in the backlight module to pass therethrough and locate within the groove 11, on the other hand not allow the circuit board pass therethrough. Although a recessed portion is formed on the outer side of the third side plate 15 as shown in FIG. 2, the outer side of the third portion 15 can be a flat surface in other examples.

As illustrated in FIG. 2, the third side plate 15 of the lampshade 1 is bent towards the opening of the groove 11 so as to form a recessed portion 16 for accommodating the circuit board. In another example, the recessed portion 16 can be formed by partly thinning the third side plate 15 from the outer side of the third side plate 15. The shape of the recessed portion 16 can be matched with the shape of the circuit board to be accommodated. The plural through holes 111 are communicated with the groove 11 and the recessed portion 16. The provision of the recessed portion 16 can reduce the dimension of the backlight module. Meanwhile, as the circuit board is embedded into the lampshade, the assembly and positioning of the LED lamps can be facilitated.

As illustrated in FIG. 2, the first side plate 13 and the second side plate 14 are parallel to each other; the third side plate 15 is connected with the first side plate 13 and the second side plate 14 in such a way that the groove 11 is formed on the first side of the third side plate 15; and the third side plate 15 is bent towards the opening of the groove 11 so as to form the recessed portion 16 for accommodating the circuit board.

In the embodiment, the first side plate 13, the second side plate 14 and the third side plate 15 are examples of a first portion, a second portion and a third portion of the lampshade respectively. In other embodiments, the first portion, the second portion and the third portion of the lampshade can be in other shape and can be connected with each other at any other angle. The through holes 111 are not limited to be rectangular as shown in FIG. 2 and can also be circular, triangular and the like. In addition, the plural through holes 111 can also be combined into a large through hole configured to allow a plurality of LED lamps or all the LED lamps to pass therethrough.

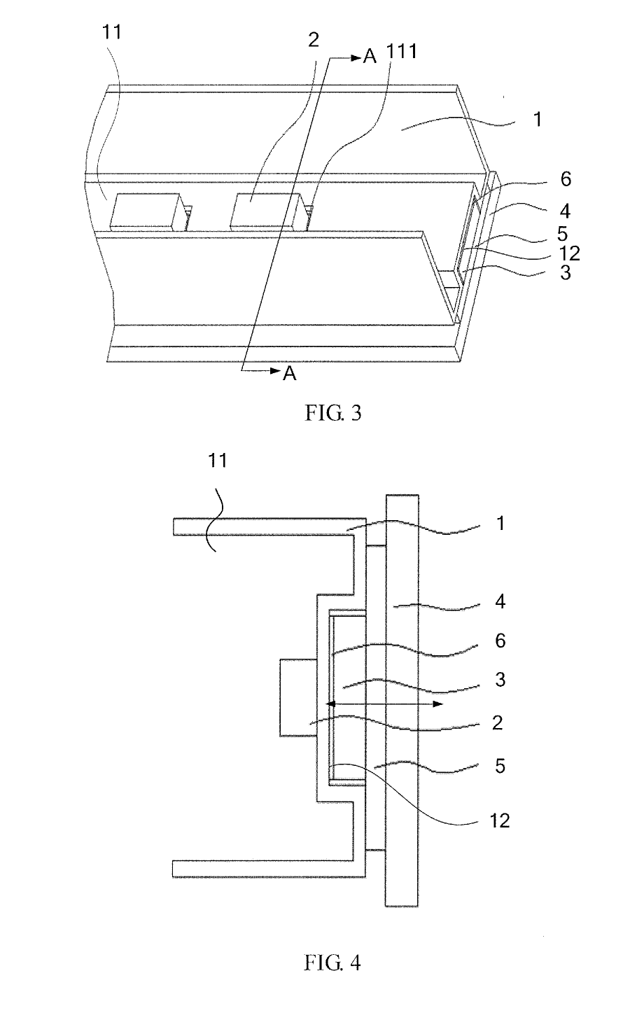

When the lampshade 1 provided by the first embodiment of the present disclosure is applied to the backlight module, as illustrated in FIGS. 3 and 4, the lampshade 1 is fixed to a backplane 4 through the bonding surface 12; since the third side plate is provided with a plurality of through holes 111 communicated with the groove 11 and each through hole 111 is configured to allow passage of at least one LED lamp 2 but not allow passage of the circuit board 3 in the backlight module, the circuit board 3 in the backlight module is disposed on the outer side the lampshade 1 when the lampshade is applied to the backlight module; the side of the circuit board away from the bonding surface 12 of the lampshade 1 makes contact with the backplane 4 in the backlight module, so that heat generated by the plurality of LED lamps 2 on one hand can be transmitted to the lampshade 1 and emitted out through the lampshade 1, on the other hand can be transmitted to the backplane 4 and emitted out through the backplane 4. When the lampshade provided by the first embodiment of the present disclosure is applied to the backlight module, the conventional unidirectional heat conduction for the plurality of LED lamps is converted into a bidirectional heat conduction (as shown by an arrow in FIG. 4), so that the heat dissipation efficiency can be greatly improved. Meanwhile, compared with the lampshade in the related art, the heat generated by the LED lamps in the backlight module passes through a smaller number of carriers, so that restriction of thermal resistivity can be correspondingly reduced, and hence the heat dissipation effect of the plurality of LED lamps can be improved.

Therefore, the lampshade for the backlight module, provided by the first embodiment of the present disclosure, has good heat dissipation function.

### Second Embodiment

FIG. 3 is a partial structural perspective view of a backlight module provided by the second embodiment of the present disclosure. FIG. 4 is a sectional view in the A-A direction of the backlight module of FIG. 3 provided by the second embodiment of the present disclosure.

As illustrated in FIGS. 3 and 4, the backlight module provided by the second embodiment of the present disclosure comprises a backplane 4, a circuit board 3 disposed on the backplane 4 and LED lamps 2 disposed on the circuit board 3 and the lampshade I provided by the first embodiment. The lampshade 1 is disposed on the backplane 4; the LED lamps 2 pass through the through holes 111 and are disposed within the groove 11 on the inner side of the third side plate 15; and the circuit board 3 is disposed on the outer side of the third side plate 15 as it cannot passes through the through holes 111 in the third side plate 15 of the lampshade 1. In one example, the lampshade 1 is connected to the circuit board 3 through the bonding surface 12.

As illustrated in FIG. 3, in the backlight module provided by the second embodiment of the present disclosure, the LED lamps are disposed within the groove 11 on the inner side of the third side plate 15 of the lampshade I and the circuit board 3 is disposed on the outer side of the third side plate 15 of the lampshade 1 (namely not disposed within the groove) by providing the through holes 111 in the lampshade 1; and the side of the circuit board 3 opposite to the side provided with the LED lamps is connected to the backplane 4 in the backlight module. Therefore, the heat generated by the plurality of LED lamps 2 on one hand can be transmitted to the lampshade and emitted out through the lampshade, on the other hand can be transmitted to the backplane 4 and emitted out through the backplane 4. In the backlight module provided by the second embodiment of the present disclosure, the unidirectional heat conduction for the plurality of LED lamps is converted into bidirectional heat conduction (as shown by the arrow in FIG. 4), thus greatly improving the heat dissipation efficiency. Meanwhile, compared with the lampshade in the related art, the heat generated by the LED lamps in the backlight module provided by the embodiment of the present disclosure passes through a smaller number of carriers, so that restriction of thermal resistivity can be correspondingly reduced, and hence the heat dissipation effect of the plurality of LED lamps can be improved.

Therefore, the backlight module provided by the second embodiment of the present disclosure can improve the heat dissipation effect of the LED lamps and prolong the service life of the LED lamps and hence can prolong the service life of a display device.

In an example, a heat-conducting insulation layer 5 is disposed between the circuit board 3 and the backplane 4; and thermal resistivity of the heat-conducting insulation layer 5 is smaller than that of the lampshade 1. Thermal resistivity is an important parameter for evaluating heat conduction efficiency. The higher the thermal resistivity is, the worse the heat conduction efficiency or the heat dissipation capacity is. The lower the thermal resistivity is, the better the heat conduction efficiency or the heat dissipation capacity is. As the thermal resistivity of the heat-conducting layer is lower, better conduction can be achieved when the heat passes through the heat-conducting layer. The heat-conducting layer may be made of silicone-based material.

In an example, as illustrated in FIG. 3, there are a plurality of LED lamps 2; the plural through holes 111 of the lampshade 1 are in one-to-one correspondence with the plural LED lamps 2; and each through hole 111 is configured to allow one of the LED lamps 2 to pass therethrough.

Moreover, each of the through holes 111 can be configured to allow one LED lamp 2 and a corresponding welding spot formed between the LED lamp 2 and the circuit board 3 to pass therethrough. That is, each through hole 111 can be configured to allow one LED lamp 2 and the welding spot formed between the LED lamp 2 and the circuit board 3 to pass therethrough, so that the lampshade can be kept away from the welding spot formed between the bottom of the LED lamp 2 and the circuit board 3, and hence short circuit between the lampshade and the LED lamp can be avoided.

In an example, a recessed portion 16 for accommodating the circuit board 3 is formed on the outer side of the third side plate 15 of the lampshade 1. The shape of the recessed portion 16 can be matched with the shape of the circuit board 3. For instance, the depth of the recessed portion 16 is greater than or equal to the thickness of the circuit board 3. Thus, the circuit board 3 can be completely disposed within the recessed portion 16, and hence the spacing between the LED lamp 2 and the backplane 4 can be reduced. Compared with the related art, the dimension of the whole backlight module will not be increased while the heat-conducting insulation layer is added. Meanwhile, due to provision of the recessed portion 16, the circuit board can be embedded into the lampshade, and hence the assembling and positioning of the LED lamps can be facilitated.

In an example, the lampshade is a long strip; the cross section of the recessed portion 16 is rectangular; and a center line of the recessed portion 16 in the longitudinal direction is overlapped with a center line of the lampshade in the longitudinal direction.

For instance, the bonding surface 12 of the lampshade 1 is connected with the circuit board 3 through an insulating double-faced adhesive tape 6.

### Third Embodiment

The third embodiment of the present disclosure provides a display device, which comprises the backlight module provided by the second embodiment. As the backlight module can improve the heat dissipation effect of the LED lamps and prolong the service life of the LED lamps, the service life of the display device can be prolonged. Therefore, the display device, provided by the third embodiment of the present disclosure has long service life.

According to the above description, embodiments of the present disclosure can provide at least the following structure:

(1) A lampshade for a backlight module, the backlight module comprising a circuit board and at least one light-emitting unit disposed on the circuit board, wherein the lampshade comprises a first portion, a second portion and a third potion connected between the first portion and the second portion; the third portion includes a first side and a second side opposite to the first side; the first portion, the second portion and the third portion form a groove on the first side of the third portion; the third portion is provided with at least one through hole communicated with the groove, and the at least one through hole is configured to allow the at least one light-emitting unit to pass therethrough while not allow the circuit board to pass therethrough.

(2) The lampshade according to (1), wherein a recessed portion is formed on the second side of the third portion and configured to accommodate the circuit board; and the at least one through hole is communicated with the groove and the recessed portion.

(3) The lampshade according to (1) or (2), wherein the recessed portion is formed by bending the third portion towards an opening of the groove.

(4) The lampshade according to any one of (1) to (3), wherein the first portion and the second portion are plate shaped and parallel to each other.

(5) The lampshade according to (2) or (3), wherein the depth of the recessed portion is greater than or equal to the thickness of the circuit board.

(6) The lampshade according to (2) or (3), wherein the recessed portion is strip shaped; and a center line of the recessed portion in a longitudinal direction is overlapped with a center line of the groove in the longitudinal direction.

(7) A backlight module comprising a backplane, a circuit board attached to the backplane, at least one light-emitting unit disposed on the circuit board and the lampshade according to any one of (1) to (6), wherein, the at least one light-emitting unit pass through at least one through hole such that at least one portion of the at least one light-emitting unit is disposed in the groove on the first side of the third portion of the lampshade and the circuit board is disposed on the second side of the third portion of the lampshade opposite to the first side.

(8) The backlight module according to (7), wherein a recessed portion is formed on the second side of the third portion and configured to accommodate the circuit board; and the at least one through hole are communicated with the groove and the recessed portion.

(9) The backlight module according to (7) or (8), wherein the at least one light-emitting unit are in one-to-one correspondence with the at least one through hole.

(10) The backlight module according to any one of (7) to (9), wherein each through hole is configured to allow corresponding light-emitting unit and a welding spot formed between the corresponding light-emitting unit and the circuit board to pass therethrough.

(11) The backlight module according to any one of (7) to (10), wherein a welding spot is formed between each light-emitting unit and the circuit board, and each through hole is configured to allow the corresponding light-emitting unit and the welding spot to pass therethrough.

(12) The backlight module according to any one of (8) to (11), the recessed portion of the lampshade is formed by bending the third portion towards an opening of the groove; the circuit board is disposed within the recessed portion; and the depth of the recessed portion is greater than or equal to the thickness of the circuit board.

(13) The backlight module according to any one of (8) to (11), wherein the recessed portion of the lampshade is formed by partially thinning the third portion on the second side thereof; the circuit board is disposed within the recessed portion; and the depth of the recessed portion is greater than or equal to the thickness of the circuit board.

(14) The backlight module according to any one of (7) to (13), wherein the lampshade is connected with the circuit board on the second side of the third portion through an insulating double-faced adhesive tape.

(15) The backlight module according to any one of (7) to (14), wherein the light-emitting unit is a light emitting diode lamp.

(16) A display device comprising the backlight module according to any one of (7) to (15).

Although detailed description has been given above to the present disclosure with reference to general description and preferred embodiments, it will be obvious to those skilled in the art that some modifications or improvements may be made on the basis of the present disclose. Therefore, all the modifications or improvements made without departing from the spirit of the present disclosure shall fall within the scope of protection of the present disclosure.

This application claim priority to Chinese Patent Application No. 201410267146.2 filed on Jun. 16, 2014, the content of which in its entirety is herein incorporated by reference.

1. A lampshade for a backlight module, the backlight module comprising a circuit board and at least one light-emitting unit disposed on the circuit board, wherein the lampshade comprises a first portion, a second portion and a third potion connected between the first portion and the second portion; the third portion includes a first side and a second side opposite to the first side; the first portion, the second portion and the third portion form a groove on the first side of the third portion; the third portion is provided with at least one through hole communicated with the groove, and the at least one through hole is configured to allow the at least one light-emitting unit to pass therethrough while not allow the circuit board to pass therethrough.

2. The lampshade according to claim 1, wherein a recessed portion is formed on the second side of the third portion and configured to accommodate the circuit board; and the at least one through hole is communicated with the groove and the recessed portion.

3. The lampshade according to claim 1, wherein the recessed portion is formed by bending the third portion towards an opening of the groove.

4. The lampshade according to claim 1, wherein the first portion and the second portion are plate shaped and parallel to each other.

5. The lampshade according to claim 2, wherein the depth of the recessed portion is greater than or equal to the thickness of the circuit board.

6. The lampshade according to claim 2, wherein the recessed portion is strip shaped; and a center line of the recessed portion in a longitudinal direction is overlapped with a center line of the groove in the longitudinal direction.

7. The lampshade according to claim 3, wherein the depth of the recessed portion is greater than or equal to the thickness of the circuit board.

8. The lampshade according to claim 3, wherein the recessed portion is strip shaped; and a center line of the recessed portion in a longitudinal direction is overlapped with a center line of the groove in the longitudinal direction.

9. A backlight module comprising a backplane, a circuit board attached to the backplane, at least one light-emitting unit disposed on the circuit board and the lampshade according to claim 1, wherein, the at least one light-emitting unit pass through at least one through hole such that at least one portion of the at least one light-emitting unit is disposed in the groove on the first side of the third portion of the lampshade and the circuit board is disposed on the second side of the third portion of the lampshade opposite to the first side.

10. The backlight module according to claim 9, wherein a recessed portion is formed on the second side of the third portion and configured to accommodate the circuit board; and the at least one through hole are communicated with the groove and the recessed portion.

11. The backlight module according to claim 9, wherein the at least one light-emitting unit are in one-to-one correspondence with the at least one through hole.

12. The backlight module according to claim 11, wherein a welding spot is formed between each light-emitting unit and the circuit board, and each through hole is configured to allow the corresponding light-emitting unit and the welding spot to pass therethrough.

13. The backlight module according to claim 9, wherein a heat-conducting insulation layer for conducting heat is disposed between the circuit board and the backplane; and a thermal resistivity of the heat-conducting insulation layer is smaller than a thermal resistivity of the lampshade.

14. The backlight module according to claim 10, wherein a heat-conducting insulation layer for conducting heat is disposed between the circuit board and the backplane; and a thermal resistivity of the heat-conducting insulation layer is smaller than a thermal resistivity of the lampshade.

15. The backlight module according to claim 10, wherein the recessed portion of the lampshade is formed by bending the third portion towards an opening of the groove; the circuit board is disposed within the recessed portion; and the depth of the recessed portion is greater than or equal to the thickness of the circuit board.

16. The backlight module according to claim 10, wherein the recessed portion of the lampshade is formed by partially thinning the third portion on the second side thereof; the circuit board is disposed within the recessed portion; and the depth of the recessed portion is greater than or equal to the thickness of the circuit board.

17. The backlight module according to claim 9, wherein the lampshade is connected with the circuit board on the second side of the third portion through an insulating double-faced adhesive tape.

18. The backlight module according to claim 10, wherein the lampshade is connected with the circuit board on the second side of the third portion through an insulating double-faced adhesive tape.

19. The backlight module according to claim 9, wherein the light-emitting unit is a light emitting diode lamp.

20. A display device comprising the backlight module according to claim 9.
